(19) United States
(12) Patent Application Publication
(10) Pub. No.: US 2011/0248199 A1
(43) Pub. Date: Oct. 13, 2011

(54) ELECTRONIC WATER MAIN SHUTOFF

(76) Inventor: NICHOLAS K. KONOVALSKI, Richardson, TX (US)

(21) Appl. No.: 12/945,206

(22) Filed: Nov. 12, 2010

Related U.S. Application Data
(60) Provisional application No. 61/322,464, filed on Apr. 9, 2010.

(51) Int. Cl. F16K 31/04

(52) U.S. Cl. 251/129.15; 251/129.01

(57) ABSTRACT

A water shutoff apparatus enables a user to shut off water to a home or business while indoors with an electronic switch, a wireless remote, or the like. The water shutoff apparatus may be useful to turn off water flow during, for example, an emergency situation, such as a leak, or for plumbing repairs. The water shutoff apparatus may use a normally open valve, such as a diaphragm valve, solenoid valve, electric motorized ball valve, electric motorized butterfly valve, or the like. The water shutoff apparatus provides the user with an easy, practical way to shut off water. Also, the water shutoff apparatus provides the user the option to easily shut off water at night or during the day while at work, for example, if a plumbing leak is somewhat tolerable and plumbing repair is still yet to be scheduled. In this situation, when water is needed, a simple switch may turn water back on for use.

### CROSS-REFERENCE TO RELATED APPLICATION

This application claims the benefit of priority of U.S. Provisional patent application No. 61/322,464, filed Apr. 9, 2010, which is herein incorporated by reference.

### BACKGROUND OF THE INVENTION

The present invention relates to water shutoff devices and, more particularly, to an electronic water main shutoff that enables a user to shut off water to a home or business while indoors with an electronic switch, wireless remote, or the like.

Homeowners and business owners' only option in an emergency flood or normal plumbing repair situation is to manually shut off the water meter or valve upstream of the leak or plumbing repair. Often times, the water meter key is missing or the lid will not budge due to corrosion. Limited access to the water meter is also a problem for the homeowner or renter. Sometimes the closest shut off valve is in a crawl space or in a hard to get to area.

Gate valves are often used at water meters for water shutoff. A user may not be able to turn these gate valves since, each year, water meters and gate valves become more corroded and more difficult to maneuver. These gate valves are usually not meant to be exercised on a steady basis and they can become weak and brittle if used more frequently than usual, eventually leaking or breaking.

As can be seen, there is a need for a water shutoff device that allows a user a simple and practical method for shutting off water.

### SUMMARY OF THE INVENTION

In one aspect of the present invention, a water shutoff apparatus comprises a shutoff valve installed in a water line, the water line supplying water to a building; and a switch for selectively providing power to the shutoff valve, the shutoff valve closing when power is provided thereto, wherein the switch is accessible from inside the building, and the switch is located near a water tap inside the building.

In another aspect of the present invention, a water shutoff apparatus comprises a normally open solenoid diaphragm valve installed in a water line, the water line supplying water to a building; and a switch for selectively providing power to the shutoff valve, the shutoff valve closing when power is provided thereto, wherein the switch is accessible from inside the building.

In another aspect of the present invention, a method for shutting off water to a building comprises energizing a normally open valve in-line with a water supply pipe to the building via a switch located inside the building; closing the normally open valve to shut off water flow to the building.

These and other features, aspects and advantages of the present invention will become better understood with reference to the following drawings, description and claims.

### BRIEF DESCRIPTION OF THE DRAWINGS

FIG. 1 is a side elevation view of a water shutoff according to an exemplary embodiment of the present invention;

FIG. 2 is a schematic diagram showing power delivery to a shutoff valve of the water shutoff of FIG. 1; and

FIG. 3 is a perspective view of an under cabinet switch for energizing the shutoff valve of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a water shutoff apparatus that enables a user to shut off water to a home or business while indoors with an electronic switch, a wireless remote, or the like. The water shutoff apparatus may be useful to turn off water flow during, for example, an emergency situation, such as a leak, or for plumbing repairs. The water shutoff apparatus may use a normally open valve, such as a solenoid diaphragm valve, electric motorized ball valve, electric motorized butterfly valve, or the like. In some embodiments, a normally open solenoid diaphragm valve may be used to quickly shut off the flow of water. The water shutoff apparatus provides the user with an easy, practical way to shut off water. Also, the water shutoff apparatus provides the user the option to easily shut off water at night or during the day while at work, for example, if a plumbing leak is somewhat tolerable and plumbing repair is still yet to be scheduled. In this situation, when water is needed, a simple switch may turn water back on for use.

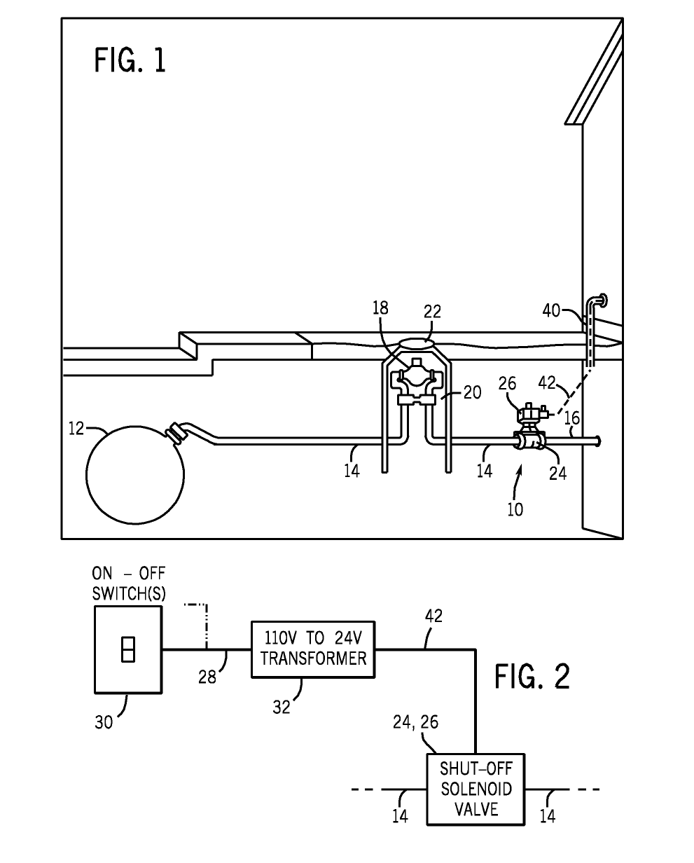

Referring to FIG. 1, a water main 12 may supply water, via a water pipe 14, to a conventional main water shutoff/meter 18. The conventional main water shutoff/meter 18 may be contained in a housing 20 and may be covered with a lid 22. As discussed above, the lid 22 may be difficult to open and, once opened, the user, looking to turn the water shutoff/meter 18 on or off, must have the appropriate key (not shown) and must be able to turn the water shutoff/meter 18.

A water shutoff apparatus 10 may be placed inline with the water pipe 14. The water shutoff apparatus 10 may be located close to the house or close to the water shutoff/meter 18. If a sprinkler system is installed, the user can elect to place the water shutoff apparatus 10 either before the sprinkler system tie-in (thus turning off the sprinkler system along with the home's water) or after the sprinkler system tie-in (thus keeping the sprinkler system functional when the home's water is turned off). In some embodiments, two water shutoff apparatus 10 may be installed, one before the sprinkler system tie-in and one after the sprinkler system tie-in. In some embodiments, the water shutoff apparatus 10 is placed underground, outside the building, as shown in FIG. 1. A water line 16 may deliver water from the shutoff apparatus 10 to the building.

The shutoff apparatus 10 may include a valve 24. The valve 24 may be, for example, a two-way electric solenoid diaphragm valve. Alternatively, the valve 24 may be an electric motorized ball valve or electric motorized butterfly valve powered by an electric motor 26 for opening and closing the valve. The solenoid diaphragm valve 24 may be designed as a normally open valve, closing only upon being energized and opening once power is removed.

The power required for a solenoid valve may be either 12 volt, 24 volt or 110 volt power. Typically, electric ball valves and butterfly valves may operate at either 12 volt or 24 volt power.

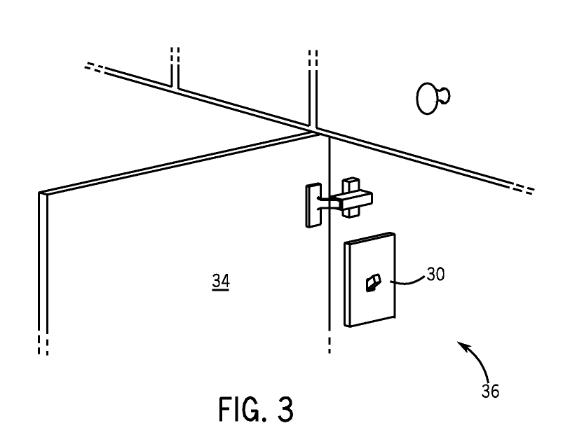

As shown in FIGS. 2 and 3, a switch 30 may be used to supply power, via a power line 28, to the shutoff apparatus 10. The power line 28 may continue outside as power line 42. A conduit 40 may bring the power line 42 from the side of the building to under the ground, according to the appropriate electrical codes.

When a voltage other than 110V is necessary, a transformer 32 may be used to convert the 110 voltage to, for example, 12 volt power or 24 volt power. The switch 30 may be placed at a location in the building where accidental switching would not occur. For example, the switch 30 may be placed behind a cabinet door 34 of a cabinet 36. The cabinet 36 may be located near a water tap inside the building, such as a sink. In this configuration, a user may flip the switch and easily determine, from their proximity to the sink, that water has been shut off (or returned back on).

In some embodiments, the switch 30 may be powered by a wireless remote control. Various electrical remote controls are known in the art, such as those sold by X10, for example. In addition, these remote control switches may be controlled from a remote site via an internet connection. In some embodiments, a timer (not shown) may be added to the system described herewithin in order to control the use of water in the building.

For the installation of the shutoff apparatus 10, the first step is the tie-in with the water supply. This may involve digging out the ground to reveal the service line and cutting the line with a gap therebetween. The shutoff apparatus 10 may be installed in this gap with conventional methods. Unions (not shown) may be installed on each side of the shutoff apparatus 10 to aid removal of the shutoff apparatus 10 if necessary at a later time. The second step involves digging a wire trench to run wire from the shutoff apparatus 10 to the building. The depth of the trench should be made according to local codes. The third step involves drilling a hole and feeding the wire into the building and connecting the wire to a switch. Typically, the wire will not be energized and the valve will be open. This configuration will keep the valve open should there be a power failure. The normally open solenoid diaphragm valve may be closed upon energizing the valve by supplying appropriate power to the valve. As discussed above, a transformer may be used to provide the appropriate power to the valve.

While the above describes tying into a water main line, the apparatus and methods of the present invention may be used for a well water supply as well. In the case of a well, the shutoff apparatus 10 may be installed between the well head and the building. In an alternate embodiment, the shutoff apparatus 10 may be installed after a pressure tank, thereby providing more immediate water shut off when the valve is energized.

It should be understood, of course, that the foregoing relates to exemplary embodiments of the invention and that modifications may be made without departing from the spirit and scope of the invention as set forth in the following claims.

What is claimed is:

1. A water shutoff apparatus comprising:
a shutoff valve installed in a water line, the water line supplying water to a building; and
a switch for selectively providing power to the shutoff valve, the shutoff valve closing when power is provided thereto, wherein
the switch is accessible from inside the building, and
the switch is located near a water tap inside the building.

2. The water shutoff apparatus of claim 1, wherein the valve is a normally open solenoid diaphram valve.

3. The water shutoff apparatus of claim 1, further comprising an electric motor for turning a valve.

4. The water shutoff apparatus of claim 3, wherein the valve is either an electric motorized ball valve or an electric motorized butterfly valve, wherein the valve is turned by the electric motor.

5. A water shutoff apparatus comprising:
a normally open solenoid diaphragm valve installed in a water line, the water line supplying water to a building; and
a switch for selectively providing power to the shutoff valve, the shutoff valve closing when power is provided thereto, wherein
the switch is accessible from inside the building.

6. The water shutoff apparatus of claim 5, wherein the water shutoff apparatus is installed on the water line between a water meter and the building.

7. The water shutoff apparatus of claim 5, wherein the switch is adapted to be switched on and off remotely.

8. The water shutoff apparatus of claim 5, wherein the switch is disposed inside the building at a location near a water tap.

9. A method for shutting off water to a building, comprising:
energizing a normally open valve in-line with a water supply pipe to the building via a switch located inside the building;
closing the normally open solenoid diaphragm valve to shut off water flow to the building.

10. The method of claim 9, further comprising:
testing the normally open valve by, prior to energizing the normally open valve, opening a water tap inside the building, the water tap being located near the switch.
